(19) United States
(12) Patent Application Publication
(10) Pub. No.: US 2026/0147364 A1
(43) Pub. Date: May 28, 2026

(54) METHOD FOR CONTROLLING COOLING FUNCTION FOR TELECOMMUNICATION BUILDING, AND SERVER DEVICE FOR SUPPORTING SAME

(71) Applicants: SK TELECOM CO., LTD., Seoul (KR); SEEDN CO., LTD., Seoul (KR)

(72) Inventors: Seongho HEO, Seoul (KR); Dongseok KONG, Seoul (KR); Hyunwoong CHOI, Gyeonggi-do (KR); Wonjin HONG, Seoul (KR)

(21) Appl. No.: 19/120,879

(22) PCT Filed: Feb. 9, 2023
(86) PCT No.: PCT/KR2023/001911

§ 371 Date: Apr. 14, 2025

(30) Foreign Application Priority Data
Oct. 14, 2022 (KR) 10-2022-0132776

(51) Int. Cl. G05D 23/19

(52) U.S. Cl. CPC G05D 23/1917

(57) ABSTRACT

A server processor of a server device, according to an embodiment of the present invention, can be configured to: calculate a predicted communication traffic volume processed through a telecommunication building in which a cooling system is disposed; detect, on the basis of the predicted communication traffic volume, a control area in which electronic equipment expected to overheat is disposed in the telecommunication building divided into a plurality of control areas; generate first cooling system control information for adjusting that the set temperature of a first cooling device, which is disposed for temperature adjustment of the detected control area, from among a plurality of cooling devices arranged in the telecommunication building is lowered to a pre-defined value; and transmit the first cooling system control information to the first cooling device.

### CROSS-REFERENCE TO RELATED APPLICATIONS

This application is a U.S. National Stage Application under 35 U.S.C. § 371 of PCT Application No. PCT/KR2023/001911, filed Feb. 9, 2023, which claims priority to Korean Patent Application No. 10-2022-0132776, filed Oct. 14, 2022, whose entire disclosures are incorporated by reference.

### TECHNICAL FIELD

The present disclosure relates to cooling function control, and more particularly, to a control system capable of remote control and automatic temperature control of an air conditioner for a telecommunication building.

### BACKGROUND ART

Telecommunication service providers are among the largest consumers of electricity. Most of the electricity used by telecommunication service providers is used to operate base stations or telecommunication buildings for operating telecommunication networks such as LTE (long term evolution) and 5G (5th generation). The telecommunication building is composed of a number of transmission devices and server devices that generate heat, and cooling devices for removing the generated heat, and is operated 24 hours a day, 365 days a year.

The amount of heat generated by devices that cause heat generation in the telecommunication building varies depending on communication traffic and usage amount. Thus, localized heat generation is likely to occur in a certain space of the telecommunication building, and the characteristics of heat generation vary depending on the time and day of the week patterns and the characteristics of the surrounding floating population. On the other hand, in the case of fixed-speed air conditioners, which account for the largest proportion of the telecommunication building cooling system, the compressor can only be turned on/off according to the set temperature, and control is performed based on the temperature sensor value of the intake port inside the air conditioner. Therefore, it is difficult to achieve the goal of reducing overall heat generation by controlling the output of the air conditioner according to the temperature around the cooling device.

Meanwhile, high temperatures of the telecommunication building devices are a serious problem that can lead to communication failures, so a lot of power is used by air conditioners to keep the indoor temperature low. In particular, since similar cooling operations are performed even at night, on weekends, and in winter when there is little heat generation, additional power consumption occurs due to overcooling.

As described above, a typical control method for the air conditioners in the telecommunication building is to compare the temperature sensor of the air conditioner intake with the set temperature and transmit the compressor on/off signal, and the set temperature is manually changed by a person. Here, since the air temperature around the air conditioner is determined as the temperature of the entire space of the telecommunication building, it is difficult to control the cooling according to the temperature of the entire space, and there is a problem that a response to momentary and localized heat generation is impossible. In addition, the typical control for the air conditioners in the telecommunication building does not consider external influences such as the outdoor temperature, so there is a problem that an excess or deficiency of cooling supply occurs. Also, since there is no deadband condition for the indoor temperature of the telecommunication building, there is a problem in that the compressor is repeatedly turned on and off when the indoor temperature of the telecommunication building is maintained close to the set point, resulting in loss of starting current.

### SUMMARY

Accordingly, the present disclosure is intended to provide a cooling function control method for a telecommunication building to realize a stable cooling state for the entire space of the telecommunication building by dynamically responding to the heat generation of the telecommunication building where local and instantaneous heat generation occurs, and a server device supporting the same.

In addition, the present disclosure is intended to provide a cooling function control method for a telecommunication building to improve power waste due to overcooling or unnecessary cooling supply of the telecommunication building by performing optimized cooling control using technologies such as prediction of indoor temperature changes based on air conditioner control and air conditioner operation time control through maintenance of an appropriate deadband, and a server device supporting the same.

However, the objects of the present disclosure are not limited to the above-mentioned objects, and other objects that are not mentioned can be clearly understood from the following description.

In order to accomplish the above object, a cooling function control method for a telecommunication building includes, by a server device, calculating a predicted communication traffic volume processed through the telecommunication building; by the server device, detecting a control area in which an electronic device expected to overheat is disposed, from the telecommunication building divided into a plurality of control areas, based on the predicted communication traffic volume; by the server device, generating first cooling system control information for adjusting a set temperature of a first cooling device to be lowered by a predefined value, the first cooling device being disposed for temperature adjustment of the detected control area from among a plurality of cooling devices arranged in the telecommunication building; and by the server device, transmitting the first cooling system control information to the first cooling device.

Specifically, the method may further include collecting temperature information from a temperature sensor disposed in the detected control area, and maintaining temperature setting of the first cooling device when the temperature information is below a predefined value.

Specifically, the method may further include collecting temperature information from a temperature sensor disposed in the detected control area, and generating second cooling system control information for adjusting the set temperature of the first cooling device to be further lowered by a predefined value when the temperature information is greater than or equal to a predefined value, and transmitting the second cooling system control information to the first cooling device.

Specifically, the method may further include collecting temperature information from a temperature sensor disposed in the detected control area, checking whether the set temperature of the first cooling device is a predefined lower threshold value when the temperature information is greater than or equal to a predefined value, generating third cooling system control information for adjusting a set temperature of a second cooling device which affects cooling of the detected control area to be lowered when the set temperature of the first cooling device is the predefined lower threshold value, and transmitting the third cooling system control information to the second cooling device.

Specifically, the method may further include collecting temperature information from a temperature sensor disposed in the detected control area, comparing a set temperature of a second cooling device which affects cooling of the detected control area with the set temperature of the first cooling device when the temperature information is higher than or equal to a predefined value, generating fourth cooling system control information for adjusting a set temperature of a cooling device having a relatively higher set temperature as a result of the comparison to be lowered, and transmitting the generated fourth cooling system control information to the corresponding cooling device.

Specifically, the method may further include transmitting information related to cooling control of the telecommunication building to an administrator terminal, receiving a control signal related to the cooling control from the administrator terminal, and transmitting the control signal to at least one cooling device of the telecommunication building.

Specifically, the method may further include collecting temperature information from a temperature sensor disposed in the detected control area, when the temperature information is below a predefined overcooling temperature value, checking whether set temperature adjustment of another third cooling device affecting cooling of the control area is possible, adjusting the set temperature of the first cooling device when the set temperature adjustment of the third cooling device is impossible, and adjusting the set temperature of the third cooling device when the set temperature adjustment of the third cooling device is possible.

A server device (or a cloud server) according to an embodiment of the present disclosure may include a server memory storing at least one threshold value related to an operation of a cooling system, a server communication circuit forming a communication channel with at least some components of the cooling system, and a server processor functionally connected to the server memory and the server communication circuit. The server processor is configured to calculate a predicted communication traffic volume processed through the telecommunication building in which the cooling system is disposed, detect a control area in which an electronic device expected to overheat is disposed, from the telecommunication building divided into a plurality of control areas, based on the predicted communication traffic volume, generate first cooling system control information for adjusting a set temperature of a first cooling device to be lowered by a predefined value, the first cooling device being disposed for temperature adjustment of the detected control area from among a plurality of cooling devices arranged in the telecommunication building, and transmit the first cooling system control information to the first cooling device.

Specifically, the server processor may be configured to collect temperature information from a temperature sensor disposed in the detected control area, maintain temperature setting of the first cooling device when the temperature information is below a predefined value, generate second cooling system control information for adjusting the set temperature of the first cooling device to be further lowered by a predefined value when the temperature information is greater than or equal to a predefined value, and transmit the second cooling system control information to the first cooling device, or check whether the set temperature of the first cooling device is a predefined lower threshold value when the temperature information is greater than or equal to a predefined value, generate third cooling system control information for adjusting a set temperature of a second cooling device which affects cooling of the detected control area to be lowered when the set temperature of the first cooling device is the predefined lower threshold value, and transmit the third cooling system control information to the second cooling device.

Specifically, the server processor may be configured to collect temperature information from a temperature sensor disposed in the detected control area, compare a set temperature of a second cooling device which affects cooling of the detected control area with the set temperature of the first cooling device when the temperature information is higher than or equal to a predefined value, generate fourth cooling system control information for adjusting a set temperature of a cooling device having a relatively higher set temperature as a result of the comparison to be lowered, and transmit the generated fourth cooling system control information to the corresponding cooling device.

Specifically, the server processor may be configured to transmit information related to cooling control of the telecommunication building to an administrator terminal, and upon receiving a control signal related to the cooling control from the administrator terminal, transmit the control signal to at least one cooling device of the telecommunication building.

Specifically, the server processor may be configured to collect temperature information from a temperature sensor disposed in the detected control area, when the temperature information is below a predefined overcooling temperature value, check whether set temperature adjustment of another third cooling device affecting cooling of the control area is possible, then adjust the set temperature of the first cooling device when the set temperature adjustment of the third cooling device is impossible, and adjust the set temperature of the third cooling device when the set temperature adjustment of the third cooling device is possible.

According to the present disclosure, the present disclosure can improve power consumption efficiency and reduce carbon emissions through AI (artificial intellectual)-based cooling optimization.

In addition, the present disclosure can stably delay time and suppress the occurrence of failures in the operation of a cooling system by replacing an analog timer with a software scheme, and when a cooling-related event situation occurs, it can improve the response to the event situation by remotely and automatically turning the cooling system on/off.

In addition, the present disclosure can prevent overcurrent occurrence to prevent cooling equipment failure and improve the life of the air conditioner.

Further, various effects other than the above-mentioned effects can be directly or implicitly disclosed in the detailed description according to embodiments of the present disclosure to be described later.

### DESCRIPTION OF DRAWINGS

FIG. 1 is a diagram illustrating an example of a cooling system operating environment that supports cooling function control for a telecommunication building according to an embodiment of the present disclosure.

FIG. 2 is a diagram illustrating an example of a cooling system configuration according to an embodiment of the present disclosure.

FIG. 3 is a diagram illustrating an example of a telecommunication building to which a cooling system according to an embodiment of the present disclosure is applied.

FIG. 4 is a diagram illustrating another example of a telecommunication building to which a cooling system according to an embodiment of the present disclosure is applied.

FIG. 5 is a diagram illustrating an example of a device configuration of a cloud server according to an embodiment of the present disclosure.

FIG. 6 is a diagram illustrating another example of a cooling system operating environment according to an embodiment of the present disclosure.

FIG. 7 is a diagram illustrating yet another example of a cooling system operating environment according to an embodiment of the present disclosure.

FIG. 8 is a diagram illustrating an example of a configuration of an administrator terminal according to an embodiment of the present disclosure.

FIG. 9 is a diagram illustrating an example of a screen interface provided in a cooling system operating environment according to an embodiment of the present disclosure.

FIG. 10 is a diagram illustrating another example of a screen interface provided in a cooling system operating environment according to an embodiment of the present disclosure.

FIG. 11 is a diagram illustrating an example of a device operating method of a cloud server related to the operation of a cooling system according to an embodiment of the present disclosure.

### DETAILED DESCRIPTION

Now, embodiments of the present disclosure will be described in detail with reference to the accompanying drawings.

However, in the following description and the accompanying drawings, well known functions and components may not be described nor illustrated in detail to avoid obscuring the subject matter of the present disclosure. In addition, identical components are indicated with the same reference numerals as much as possible throughout the drawings.

The terms or words used in the following description and drawings should not be interpreted as limited to their usual or dictionary meanings and should be interpreted as meanings and concepts that conform to the technical idea of the present disclosure based on the principle that the inventor can appropriately define the concept of the terms to best describe his or her disclosure. Therefore, embodiments described herein are only the most preferred embodiments of the present disclosure and do not represent all of the technical ideas of the present disclosure. Thus, it should be understood that there may be various equivalents and modified examples that can replace the embodiments at the time of filing this application.

In addition, terms including ordinal numbers such as first, second, etc. are used to describe various elements only for the purpose of distinguishing one element from another, and are not used to limit such elements. For example, without departing from the scope of the present disclosure, a second element may be named a first element, and similarly, a first element may also be named a second element.

In addition, terms used herein are only for describing specific embodiments and do not limit the present disclosure. The singular expression includes the plural expression unless the context clearly indicates otherwise. Also, the terms such as “comprise” and “include” used herein are intended to specify the presence of features, numerals, steps, operations, elements, components, or combinations thereof, which are disclosed herein, and should not be construed to exclude in advance the possibility of the presence or addition of other features, numerals, steps, operations, elements, components, or combinations thereof.

In addition, the terms such as “unit” and “module” used herein refer to a unit that processes at least one function or operation and may be implemented with hardware, software, or a combination of hardware and software. In addition, the terms “a”, “an”, “one”, “the”, and similar terms may be used as both singular and plural meanings in the context of describing the present disclosure (especially in the context of the following claims) unless the context clearly indicates otherwise.

In addition to the terms mentioned above, specific terms used in the following description are provided to help understanding of the present disclosure, and the use of such specific terms may be changed to other forms without departing from the technical meaning of the present disclosure.

Also, embodiments within the scope of the present disclosure include computer-readable media having computer-executable instructions or data structures stored on computer-readable media. Such computer-readable media can be any available media that is accessible by a general purpose or special purpose computer system. By way of example, such computer-readable media may include, but not limited to, RAM, ROM, EPROM, CD-ROM or other optical disk storage, magnetic disk storage or other magnetic storage devices, or any other physical storage medium that can be used to store or deliver certain program codes formed of computer-executable instructions, computer-readable instructions or data structures and which can be accessed by a general purpose or special purpose computer system.

The present disclosure relates to a cooling function control system that manages and controls an air conditioner that can be used in an unmanned telecommunication building (or a small data center or a base station, hereinafter referred to as a telecommunication building) by using a solution provided on the cloud. The present disclosure predicts the indoor temperature of the telecommunication building in advance and automatically controls the blower and compressor of the air conditioner, and in relation to this, supports AI-based cooling optimization. The present disclosure is a technology that can achieve power consumption efficiency and carbon emission reduction, and it introduces a time delay and failure prevention program by replacing the existing analog timer scheme with a software scheme, and supports achieving cooling optimization of the telecommunication building based on this.

The present disclosure provides an example of finding the optimal cooling temperature by measuring external communication traffic prediction data, outdoor temperature, etc., and applying this to the telecommunication building.

Hereinafter, the types and roles of components included in the system environment that can provide optimized alternate operation combination information of refrigerators included in the cooling system of the present disclosure will be described.

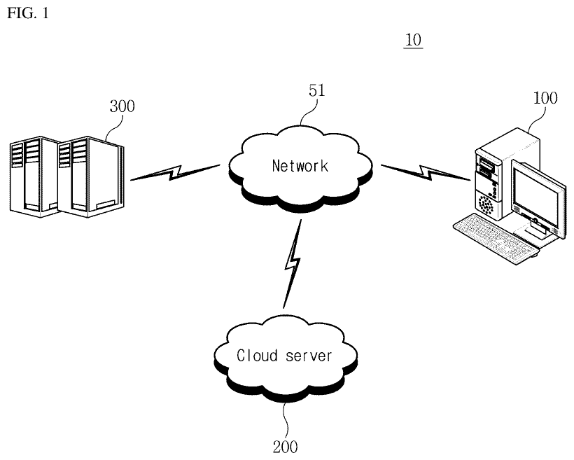

FIG. 1 is a diagram illustrating an example of a cooling system operating environment that supports cooling function control for a telecommunication building according to an embodiment of the present disclosure.

Referring to FIG. 1, the cooling system operating environment 10 according to an embodiment of the present disclosure may include at least one administrator terminal 100 (or an electronic device for an administrator), a network 51 (or at least one of a mobile communication network, an Internet network, an intranet network, and a wired cable), a cloud server 200 (or a server device, a cooling control server device), and a cooling system 300 disposed in a telecommunication building (or a facility, base station, or data center in which the cooling system is installed).

The telecommunication building may be a facility such as a base station or a data center that continuously generates heat for communication traffic operation and whose heat generation amount varies locally or instantaneously depending on communication traffic volume, or a facility that requires continuous cooling management. In the telecommunication building, a plurality of transmission devices for supporting transmission and reception of communication traffic and a plurality of server devices capable of storing the transmitted and received communication traffic may be arranged in a certain space. In particular, the telecommunication building may include the cooling system 300 including a plurality of air conditioners (or cooling devices, cooling apparatuses) capable of reducing heat generated by the transmission devices and the server devices. At least some of the transmission devices and the server devices may have different heat generation amounts depending on the communication traffic volume, and may have different heat generation amounts locally depending on an area where communication traffic increases. For example, if the telecommunication building is designed to handle communications traffic of multiple zones, the transmission devices and the server devices are provided to receive and transmit communications traffic of the respective zones, and depending on the amount of communications traffic generated in each zone, the heat generation amount of the transmission device and the server device handling a certain zone may increase compared to other zones.

The cooling system 300 can manage the temperature of the telecommunication building (or the facility where the cooling system 300 is disposed) to be below a preset temperature. The cooling system 300 may include a plurality of refrigerators (or air conditioners) for continuous temperature management, and at least some of the plurality of refrigerators may be operated alternately or as a whole. In the cooling system 300, temperature sensors may be arranged adjacent to each of devices installed in relation to communication traffic or devices generating heat, or on the surfaces of the devices, or within the devices, for temperature management of the telecommunication building, and may monitor temperature changes in each zone based on temperature information collected through the arranged temperature sensors. The cooling system 300 may determine whether to operate at least some of the cooling devices and the degree of operation in consideration of the monitored temperature changes. According to an embodiment, the cooling system 300 may check the outdoor temperature and control the indoor temperature in the telecommunication building according to the outdoor temperature.

The network 51 can support the formation of a communication channel between the cooling system 300 and the cloud server 200 and between the administrator terminal 100 and the cloud server 200. In this regard, the network 51 may include at least one communication network element. For example, the network 51 may include various cables supporting a wired communication channel, a base station supporting a wireless communication channel, a wireless access point, an address allocation device for identifying each device, a router for transmitting and receiving data, MEC (mobile edge computing), etc. In an example, the network 51 may include cables connecting the cooling system 300 and the cloud server 200 with a wire, or wireless communication elements connecting them wirelessly. In addition, the network 51 may include a wireless communication network (or a wireless mobile communication network) wirelessly connecting the administrator terminal 100 and the cloud server 200. The network 51 includes at least some of various communication elements that can form a channel for communication between the cooling system 300 and the cloud server 200 or between the administrator terminal 100 and the cloud server 200, and is not limited in type, form, or scheme. For example, the network 51 may transmit the outdoor temperature collected by the weather agency and the cooling-related information collected by the cooling system 300 to the cloud server 200, provide the cooling system control information generated by the cloud server 200 to the cooling system 300, and transmit a screen related to the cooling system control to the administrator terminal 100.

The cloud server 200 can form a communication channel with the cooling system 300 through the network 51 and receive cooling-related information collected by the cooling system 300. In addition, the cloud server 200 may collect the outdoor temperature of the telecommunication building where the cooling system 300 is disposed. In this regard, the cloud server 200 may collect location information from the cooling system 300 and collect the outdoor temperature corresponding to the location from the weather agency server. Or, a temperature sensor capable of detecting the outdoor temperature of the telecommunication building where the cooling system 300 is disposed may be deployed outside the telecommunication building, and in this case, the cloud server 200 may receive information on the outdoor temperature from the temperature sensor deployed outside the telecommunication building.

The cloud server 200 can collect information on the outdoor temperature and the indoor temperature of the telecommunication building, and control whether to operate the cooling devices and the cooling temperature so that the temperature of at least some space is below a predefined temperature according to the indoor temperature of the telecommunication building. In this regard, the cloud server 200 may collect cooling device status information and cooling device power information from cooling device status sensors and cooling device power meters disposed in the cooling devices. In this process, the cloud server 200 may control the operation of the cooling devices by using a remote controller disposed in the telecommunication building or the cooling system 300. The cloud server 200 may collect information on the operation of the cooling system 300 and the cooling control status of the telecommunication building, and provide the collected information to the administrator terminal 100. In this process, the cloud server 200 may provide information related to manual control of the cooling system 300 to the administrator terminal 100, and provide cooling-related control information corresponding to the control of the administrator terminal 100 to the telecommunication building.

The administrator terminal 100 can access the cloud server 200 through the network 51, and then receive and output various kinds of information provided by the cloud server 200. In an example, the administrator terminal 100 may be provided as a desktop PC or a portable communication device and can access the cloud server 200 via an Internet network, a Wi-Fi network, a base station, etc. The administrator terminal 100 may receive and install an application program related to the operation of the cooling system provided by the cloud server 200. Or, the administrator terminal 100 may access the cloud server 200 by using a web browser, and then receive and output a cooling system operation page provided by the cloud server 200 via the web browser. The administrator terminal 100 may output information on the current cooling control status of the telecommunication building through the cooling system operation page, output a screen interface related to manual control of the cooling system 300 of the telecommunication building, and support manual control of the cooling system 300 according to an administrator's input.

As described above, the cooling system operating environment 10 according to an embodiment of the present disclosure can continuously manage the cooling of a facility such as a telecommunication building where the local spatial heat generation varies momentarily, by disposing sensors in a plurality of zones and performing cooling control in consideration of the sensor information for the plurality of zones and the outdoor temperature of the facility so that the temperature of the plurality of zones becomes lower than a specified value. Through this, the cooling system operating environment 10 of the present disclosure stably supports temperature control of the telecommunication building, thereby preventing transmission devices or server devices necessary for the operation of the telecommunication building from being excessively overheated, supporting the provision of stable communication services, and improving the excessive operation of cooling devices to support the reduction of overall power usage.

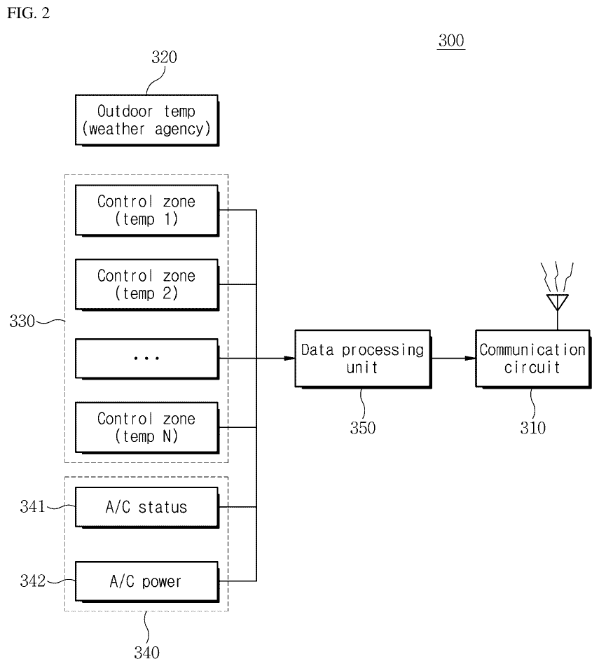

FIG. 2 is a diagram illustrating an example of a cooling system configuration according to an embodiment of the present disclosure.

Referring to FIG. 2, the cooling system 300 according to an embodiment of the present disclosure may include an outdoor temperature collector 320, a plurality of zone-specific temperature sensors 330, a plurality of cooling devices 340, a data processing unit 350, and a communication circuit 310. In addition, a hub connecting the plurality of zone-specific temperature sensors 330 may be further included. In another example, the data processing unit 350 may include the hub.

The outdoor temperature collector 320 may collect the outdoor temperature. The outdoor temperature collector 320 may access a weather agency server using the communication circuit 310 of the cooling system 300 and collect the outdoor temperature corresponding to its location. The outdoor temperature collector 320 may transmit the collected outdoor temperature to the data processing unit 350. However, if the cloud server 200 is designed to directly collect the outdoor temperature from the weather agency server, the outdoor temperature collector 320 may be omitted and not included in the cooling system 300.

The plurality of zone-specific temperature sensors 330 may be arranged in predefined zones, respectively. For example, among the plurality of zone-specific temperature sensors 330, a first temperature sensor may be disposed in a first control zone, a second temperature sensor may be disposed in a second control zone, and an Nth temperature sensor may be disposed in an Nth control zone. Here, N may be a natural number. The temperature sensors 330 may be provided to correspond to the number of control zones. The plurality of temperature sensors 330 may be connected to the data processing unit 350 via the hub. The plurality of temperature sensors 330 may collect temperature information of corresponding control zones at a specified time cycle and transmit the collected temperature information to the data processing unit 350.

The plurality of cooling devices 340 may include an air conditioner for cooling and an air conditioner controller for controlling the air conditioner. The cooling devices 340 may be arranged, for example, in multiple numbers at designated locations of the telecommunication building. In an example, the cooling devices 340 may be arranged in multiple numbers at the edge of the telecommunication building. The air conditioner controller may include individual controllers for temperature control of each of the cooling devices 340. For example, when there are three cooling devices 340, three individual controllers may also be provided. The individual controller may control the operation of the air conditioner with infrared rays, like a general remote controller. For example, the air conditioner controller may further include a remote controller. The remote controller may be a device that controls the individual controller. Thus, the individual controller may be connected in communication to the cloud server 200, or the administrator terminal 100 installed in an administrative office where an administrator managing the telecommunication building works, via the remote controller.

Each of the plurality of cooling devices 340 may include, for example, an air conditioner status sensor 341 and an air conditioner power meter 342. The air conditioner status sensor 341 may collect information about the on/off of the cooling devices 340, temperature setting information of the cooling devices 340, whether the cooling devices 340 are broken, etc., and may transmit the collected information to the data processing unit 350. The air conditioner power meter 342 may measure the amount of power consumed by the cooling devices 340 and transmit the measured power amount information to the data processing unit 350. Meanwhile, although it is described above that the air conditioner status sensor 341 and the air conditioner power meter 342 are disposed in each of the cooling devices 340, one sensor and power meter may be provided to collect status information and power amounts of the plurality of cooling devices 340.

The data processing unit 350 may collect temperature information for each control zone from the plurality of temperature sensors 330 at a specified cycle or in real time, and transmit the collected temperature information to the cloud server 200 via the communication circuit 310. In addition, the data processing unit 350 may collect operating information of the cooling devices 340 (e.g., air conditioner status sensor information collected by the air conditioner status sensor 341 and air conditioner power consumption information collected by the air conditioner power meter 342) at a specified cycle or in real time, and transmit the collected information to the cloud server 200 via the communication circuit 310. For example, the data processing unit 350 may receive cooling system control information for controlling the cooling devices 340 via the communication circuit 310, and transmit the received cooling system control information to an individual controller for controlling each of the cooling devices 340 or a remote controller for managing the individual controller. Here, at least some of the remote controller and the individual controllers may be provided as part of the data processing unit 350.

The communication circuit 310 may form a communication channel between the cloud server 200 and the data processing unit 350. Or, the communication circuit 310 may support a communication connection of a hub included in the data processing unit 350 or a hub provided independently from the data processing unit 350. According to an example, the communication circuit 310 may include a modem (e.g., LTE CatM1, RS232) for the communication connection.

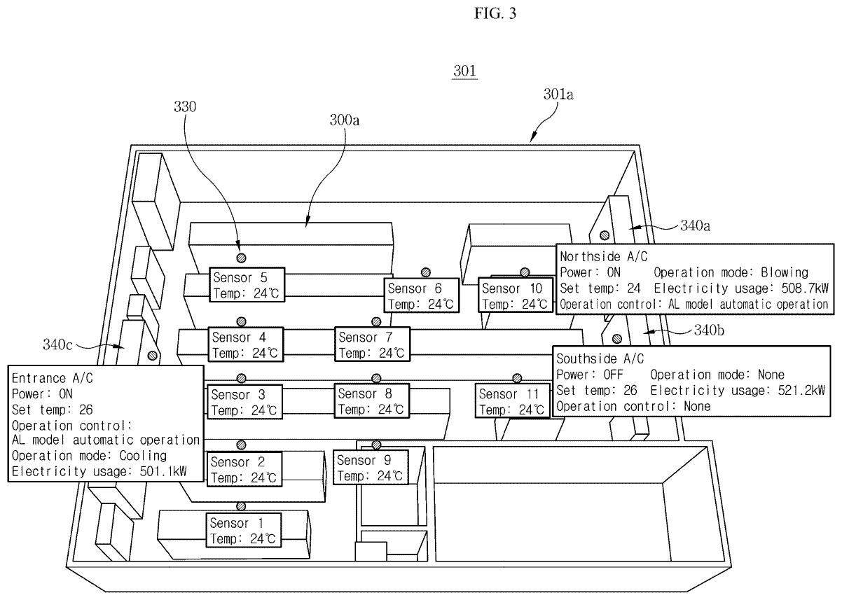

FIG. 3 is a diagram illustrating an example of a telecommunication building to which a cooling system according to an embodiment of the present disclosure is applied.

Referring to FIGS. 2 and 3, a first type telecommunication building 301 according to an embodiment may include a plurality of electronic devices 300a for transmitting and receiving communication traffic, a plurality of temperature sensors 330, a plurality of cooling devices 340a, 340b, and 340c, and an isolation facility 301a surrounding the above-mentioned components. Here, the cooling system described above may include, for example, the plurality of temperature sensors 330 and the plurality of cooling devices 340a, 340b, and 340c, and also the telecommunication building in FIG. 3 may further include the data processing unit and the communication circuit described in FIG. 2 in relation to the operation of the cooling system.

The plurality of electronic devices 300a may include transmission devices for transmitting and receiving communication traffic and server devices. The plurality of electronic devices 300a may vary in at least some of the number, size, and shape of transmission devices and server devices depending on the amount of communication traffic to be processed by the first type telecommunication building 301.

The plurality of temperature sensors 330 may be evenly distributed in areas where the plurality of electronic devices 300a are arranged. In particular, the plurality of temperature sensors 330 may be arranged at a predetermined interval in the areas where the plurality of electronic devices 300a are arranged. The plurality of temperature sensors 330 may collect temperature information at designated locations and transmit the collected temperature information to the data processing unit 350 (or hub) described above in FIG. 2.

The plurality of cooling devices 340a, 340b, and 340c may be, for example, evenly arranged at certain locations within the isolation facility 301a. For example, the plurality of cooling devices 340a, 340b, and 340c may include a first cooling device 340a disposed on the north side of the isolation facility 301a, a second cooling device 340b disposed on the south side of the isolation facility 301a, and a third cooling device 340c disposed on the entrance side of the isolation facility 301a. Meanwhile, although it is exemplified for describing the first type telecommunication building 301 that the first to third cooling devices 340a, 340b, and 340c are disposed, the number, size, and shape of cooling devices that can be disposed in the telecommunication building may vary depending on the administrator's policy. The plurality of cooling devices 340a, 340b, and 340c may discharge cooling air at a set temperature in response to the cooling system control information transmitted from the data processing unit 350 described above in FIG. 2. Or, the first type telecommunication building 301 may further include individual controllers for driving the plurality of cooling devices 340a, 340b, and 340c, and the individual controllers may perform the on/off and temperature control of the respective cooling devices 340a, 340b, and 340c in response to the cooling system control information transmitted from the data processing unit 350.

The isolation facility 301a is a structure that surrounds the plurality of electronic devices 300a, the plurality of temperature sensors 330, and the plurality of cooling devices 340a, 340b, and 340c, and may have a closed structure for efficient cooling operation. However, the isolation facility 301a may further include a ventilation passage for ventilation with the outside to allow circulation of outside air. The shape, size, and structure of the isolation facility 301a may vary depending on the size and arrangement of the plurality of electronic devices 300a.

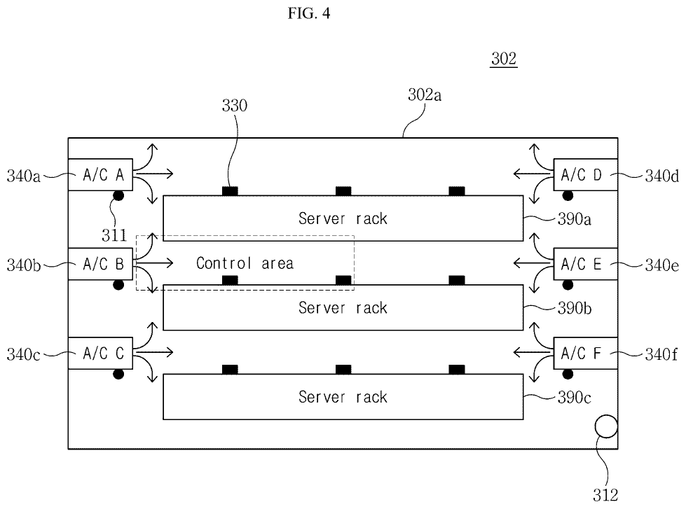

FIG. 4 is a diagram illustrating another example of a telecommunication building to which a cooling system according to an embodiment of the present disclosure is applied.

Referring to FIGS. 2 and 4, a second type telecommunication building 302 according to an embodiment may include a plurality of server racks 390a, 390b, and 390c (or electronic devices placed on the server racks) on which electronic devices for transmitting and receiving communication traffic are placed, a plurality of temperature sensors 330, a plurality of cooling devices 340a, 340b, 340c, 340d, 340e, and 340f, an isolation facility 302a surrounding the above-mentioned components, individual controllers 311 for controlling the plurality of cooling devices 340a, 340b, 340c, 340d, 340e, and 340f, and a remote controller 312. Here, the cooling system deployed in the telecommunication building may include the plurality of temperature sensors 330, the plurality of cooling devices 340a, 340b, 340c, 340d, 340e, and 340f, the individual controllers 311, and the remote controller 312, and it may further include the data processing device and the communication circuit described in FIG. 2 in relation to the operation of the cooling system.

The isolation facility 302a may be provided in various structures in which the plurality of server racks 390a, 390b, and 390c, the plurality of temperature sensors 330, and the plurality of cooling devices 340a, 340b, 340c, 340d, 340e, and 340f can be placed. Although the shape of the isolation facility 302a is exemplified as a rectangular space in the horizontal direction in the drawing, the present disclosure is not limited thereto. For example, the isolation facility 302a may include polygonal or oval (or circular) sidewalls that close a certain space to ensure a smooth flow of cooling air for cooling, depending on the arrangement or size of components arranged therein, and a structure that closes the roof and floor of the sidewalls.

The plurality of server racks 390a, 390b, and 390c on which the plurality of electronic devices are placed may include, for example, a first server rack 390a on which the first electronic devices are placed, a second server rack 390b on which the second electronic devices are placed, and a third server rack 390c on which the third electronic devices are placed. The server racks 390a, 390b, and 390c may vary depending on the shape or size of the placed electronic devices. For example, when the electronic devices have a structure formed long in the horizontal direction, the server racks 390a, 390b, and 390c may also be formed long in the horizontal direction corresponding to the shape of the electronic devices. The plurality of server racks 390a, 390b, and 390c may be arranged, for example, at the center of the isolation facility 302a or spaced apart from the sidewalls of the isolation facility 302a in an inward direction at a certain interval. In addition, the server racks 390a, 390b, and 390c may be arranged spaced apart from each other. In an example, the spaced distance between the first and second server racks 390a and 390b and the spaced distance between the second and third server racks 390b and 390c may be formed to be the same. However, such spaced distances or the arrangement locations of the server racks 390a, 390b, and 390c may vary depending on the administrator's policy for the cooling system operation. Or, the number, size and location of the server racks 390a, 390b, and 390c may vary depending on the amount of communication traffic to be processed by the second type telecommunication building 302.

The plurality of temperature sensors 330 may be evenly distributed in the server racks 390a, 390b, and 390c in which the plurality of electronic devices are respectively placed. For example, some of the plurality of temperature sensors 330 may be disposed at multiple points of the first server rack 390a, similarly, some of the other sensors may be disposed at multiple points of the second server rack 390b, and the remaining sensors may be disposed at multiple points of the third server rack 390c. Although it is illustrated in the drawing that three temperature sensors 330 are disposed in each of the server racks 390a, 390b, and 390c, the present disclosure is not limited thereto. For example, depending on the size of the server racks 390a, 390b, and 390c or the amount of heat generated by the electronic devices, a greater number of temperature sensors may be placed, or a smaller number of temperature sensors may be placed. The plurality of temperature sensors 330 may collect temperature information and transmit the collected temperature information to the data processing unit 350.

The plurality of cooling devices 340a, 340b, 340c, 340d, 340e, and 340f may be, for example, evenly arranged at certain locations within the isolation facility 302a. For example, each of the plurality of cooling devices 340a, 340b, 340c, 340d, 340e, and 340f may be arranged at edge of the isolation facility 302a. In an example, based on the illustrated drawing, the plurality of cooling devices 340a, 340b, 340c, 340d, 340e, and 340f may include a first cooling device 340a, a second cooling device 340b, and a third cooling device 340c arranged on the left sidewall of the isolation facility 302a so as to blow cooling air toward the center of the isolation facility 302a, and a fourth cooling device 340d, a fifth cooling device 340e, and a sixth cooling device 340f arranged on the right sidewall of the isolation facility 302a so as to blow cooling air toward the center of the isolation facility. The plurality of cooling devices 340a, 340b, 340c, 340d, 340e, and 340f may be arranged to be spaced apart from each other. In an example, the plurality of cooling devices 340a, 340b, 340c, 340d, 340e, and 340f may be arranged to blow cooling air into a space between the server racks 390a, 390b, and 390c. For example, the first cooling device 340a and the fourth cooling device 340d may be arranged to blow cooling air into a space between the north sidewall of the isolation facility 302a and the first server rack 390a. The second cooling device 340b and the fifth cooling device 340e may be arranged to blow cooling air into a space between the first server rack 390a and the second server rack 390b in the isolation facility 302a. The third cooling device 340c and the sixth cooling device 340f may be arranged to blow cooling air into a space between the second server rack 390b and the third server rack 390c in the isolation facility 302a. According to an example, a space between the first server rack 390a and the second server rack 390b located in front of the second cooling device 340b may be defined as a control area of the second cooling device 340b. Similarly, a particular space into which each of the cooling devices 340a, 340b, 340c, 340d, 340e, and 340f blows cooling air may be set as a control area of the corresponding cooling device. Each of the cooling devices 340a, 340b, 340c, 340d, 340e, and 340f manages the temperature values of the server racks 390a, 390b, and 390c in the control area. At this time, the adjacent cooling devices may affect the temperature of the control area. For example, the second cooling device 340b and the third cooling device 340c may affect the temperature of the illustrated control area.

The individual controllers 311 may be arranged adjacent to the plurality of cooling devices 340a, 340b, 340c, 340d, 340e, and 340f or electrically connected to the plurality of cooling devices 340a, 340b, 340c, 340d, 340e, and 340f so as to individually control each of the plurality of cooling devices 340a, 340b, 340c, 340d, 340e, and 340f. The individual controllers 311 may be arranged to correspond to the number of the plurality of cooling devices 340a, 340b, 340c, 340d, 340e, and 340f.

The remote controller 312 may be included in the hub or the data processing unit, or may be provided to perform the role of the hub or the data processing unit. The remote controller 312 may collect temperature information from temperature sensors 330, transmit it to the cloud server 200, and receive cooling system control information from the cloud server 200 or the administrator terminal 100. The remote controller 312 may generate a control signal to control the individual controllers 311 based on the received cooling system control information, and transmit the generated control signal to the individual controllers 311. In response to the control signal received from the remote controller 312, the individual controllers 311 may perform the on/off control of the cooling devices 340a, 340b, 340c, 340d, 340e, and 340f and temperature control for cooling air.

According to an embodiment, the remote controller 312 may transmit information received from the temperature sensors 330 to the cloud server 200, and the remote controller 312 may receive from the cloud server 200 the cooling system control information that requests temperature adjustment (e.g., lowering by −2 degrees) of the control area governed by the second cooling device 340b. The remote controller 312 may generate a control signal for temperature adjustment of the second cooling device 340b by checking the received cooling system control information, and then transmit the control signal to the individual controller for controlling the second cooling device 340b to lower the temperature of the control area of the second cooling device 340b. In another example, the remote controller 312 may directly form a communication channel with the administrator terminal 100. The remote controller 312 may receive cooling system control information provided by the administrator terminal 100, and control the cooling on/off or cooling level of the cooling devices 340a, 340b, 340c, 340d, 340e, and 340f in response to the received cooling system control information. Meanwhile, although it is described above that the remote controller 312 transmits the temperature information of the temperature sensors 330 to the cloud server 200, the remote controller 312 may directly transmit the collected temperature information to the administrator terminal 100.

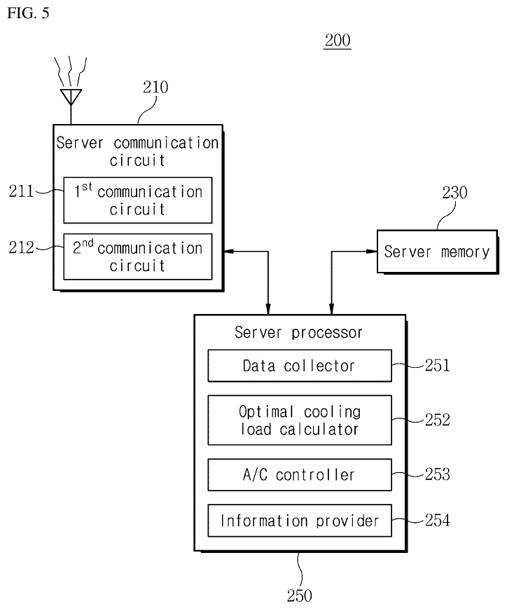

FIG. 5 is a diagram illustrating an example of a device configuration of a cloud server according to an embodiment of the present disclosure.

Referring to FIGS. 1 to 5, the cloud server 200 (or control server device) of the present disclosure may include a server communication circuit 210, a server memory 230, and a server processor 250.

The server communication circuit 210 (or server communication interface) may support forming communication channels with the cooling system 300 and the administrator terminal 100. In this regard, the server communication circuit 210 may include a first communication circuit 211 for forming a communication channel with the cooling system 300, and a second communication circuit 212 for forming a communication channel with the administrator terminal 100. The first communication circuit 211 and the second communication circuit 212 are not limited to a specific communication scheme, communication type, or communication module type. The first communication circuit 211 and the second communication circuit 212 may be communication circuits of the same type or operating in the same scheme, or may be different communication circuits. In the server communication circuit 210, the first communication circuit 211 may receive cooling-related information from the cooling system 300 and provide cooling system control information to the cooling system 300 under the control of the server processor 250. In the server communication circuit 210, the second communication circuit 212 may provide operation information of the cooling system 300 or cooling system control information to the administrator terminal 100 and receive control information regarding manual control of the cooling system 300 from the administrator terminal 100.

The server memory 220 may store at least one program and data required for the operation of the cloud server 200. For example, the server memory 220 may accumulatively store cooling system operation information provided according to the operation of the cooling system 300. In addition, the server memory 230 may store information on communication traffic volume in the telecommunication building, for each electronic device or server rack. The server memory 230 may store information on the amount of heat generated according to the communication traffic volume.

The server processor 250 may receive cooling-related information (e.g., temperature information collected by temperature sensors, status information of cooling devices (e.g., 340a to 340f in FIG. 4), power amount information, and communication traffic volume information) from the cooling system 300, and then generate and provide cooling system control information for operating the cooling system 300 based on the received cooling-related information. In this regard, the server processor 250 may include a data collector 251, an optimal cooling load calculator 252, an air conditioner controller 253, and an information provider 254.

The data collector 251 may collect cooling-related information related to the operation of the cooling system 300 at a predefined time point or in response to an administrator's request or a request from the administrator terminal 100. For example, the cooling-related information may include communication traffic volume being processed at the telecommunication building, temperature information collected by the temperature sensors 330, and status information of the cooling devices (340a to 340c in FIG. 3 or 340a to 340f in FIG. 4, hereinafter 340). According to an example, the data collector 251 may collect the cooling-related information at a specified time interval. Or, if the communication traffic volume increases above a specified reference value when the data collector 251 collects information on the communication traffic volume, the data collector 251 may collect the remaining information of the cooling-related information, such as temperature information and status information of the cooling devices 340. Or, the data collector 251 may collect only information on the communication traffic volume as a priority, provide cooling system control information to the cooling system 300, and then collect temperature information from the temperature sensors 330. The data collector 251 may collect the outdoor temperature value from the cooling system 300 or access the weather agency server to collect the outdoor temperature.

The optimal cooling load calculator 252 may generate cooling system control information for temperature control of the cooling system 300 based on the cooling-related information collected by the data collector 251. For example, the optimal cooling load calculator 252 may use a predicted value to prevent overheating and overcooling of the cooling devices 340. For example, the optimal cooling load calculator 252 may calculate a predicted outdoor temperature at a certain time point in the future (e.g., 1 hour later) before the control time point of the cooling devices 340 and a predicted traffic volume in the control areas governed by the cooling devices 340. The predicted traffic volume may include a value derived by learning using the communication traffic volume collected up to now and the past traffic volume under the same or similar conditions (e.g., conditions of the same or similar points in time when various events occur).

The optimal cooling load calculator 252 may, at the control point in time, designate an electronic device that will overheat based on the predicted outdoor temperature and predicted traffic volume, identify a control area in which the electronic device is disposed, and then generate cooling system control information including a set temperature value of the minimum power required for cooling devices in charge of the control area to prevent the electronic device from overheating. Here, the optimal cooling load calculator 252 may set the set temperature lower as the predicted outdoor temperature is higher and as the predicted traffic volume is larger. In another example, the optimal cooling load calculator 252 may identify the predicted outdoor temperature (or actual outdoor temperature) and the set temperature, and create cooling system control information to use the outdoor temperature if the predicted outdoor temperature (or actual outdoor temperature) is lower than the set temperature. The optimal cooling load calculator 252 may generate cooling system control information to maintain the current state if the predicted traffic volume is less than a specified value.

When the cooling system 300 drives at least some of the cooling devices 340 according to the set temperature included in the cooling system control information transmitted from the cloud server 200, the data collector 251 may collect temperature information for each area (or control zone) from the temperature sensors 330 of the cooling system 300. If there is no electronic device that is overheated or overcooled as a result of analyzing the collected temperature information, the optimal cooling load calculator 252 may determine that the cooling devices 340 are operated at an appropriate set temperature, thereby controlling the cooling devices 340 to maintain the operating state.

If there is an overheated electronic device among the electronic devices, the optimal cooling load calculator 252 may additionally adjust the set temperature of the cooling devices in the control area where the overheated electronic device is located. For example, if the electronic devices in the control area in the direction where the cooling air of the second cooling device 340b described above in FIG. 4 is blown are overheated, the optimal cooling load calculator 252 may generate cooling system control information that lowers the set temperature of at least one of the fourth cooling device 340d or the third cooling device 340c adjacent to the second cooling device 340b. For example, the optimal cooling load calculator 252 may determine whether the set temperature of the fourth cooling device 340d (or the third cooling device 340c) can be further lowered, and if it is determined that the set temperature of the fourth cooling device 340d (or the third cooling device 340c) cannot be changed, it may generate cooling system control information to further lower the set temperature of the second cooling device 340b. For example, the optimal cooling load calculator 252 may compare the current set temperature of the fourth cooling device 340d with the current set temperature of the second cooling device 340b, and if the current set temperature of the fourth cooling device 340d is lower than that of the second cooling device 340b, it may control the set temperature of the second cooling device 340b to be further lowered. Or, if the current set temperature of the fourth cooling device 340d reaches a predefined lower limit threshold value, the optimal cooling load calculator 252 may control the set temperature of the second cooling device 340b (or the third cooling device 340c) to be lowered without further changing the set temperature of the fourth cooling device 340d. Here, the lower limit threshold value may be defined as a limit temperature to which the temperature of the cooling device can be lowered.

In another example, the optimal cooling load calculator 252 may determine that the set temperature of the fourth cooling device 340d can be changed, and check whether the set temperature of the second cooling device 340b is higher than the set temperature of the fourth cooling device 340d. If the set temperature of the second cooling device 340b is determined to be higher than the set temperature of the fourth cooling device 340d, the optimal cooling load calculator 252 may control the set temperature of the second cooling device 340b to be lowered in terms of energy efficiency. If the set temperature of the second cooling device 340b is determined to be lower than the set temperature of the fourth cooling device 340d, the optimal cooling load calculator 252 may control the set temperature of the fourth cooling device 340d to be lowered in terms of energy efficiency.

In another example, if there is an overcooled electronic device among the electronic devices in the control area of the second cooling device 340b, the optimal cooling load calculator 252 may determine whether the set temperature of a neighboring cooling device, e.g., the first cooling device 340a (or the third cooling device 340c), of the second cooling device 340b can be increased. If it is determined that the set temperature of the first cooling device 340a cannot be changed (e.g., if the set temperature of the first cooling device 340a reaches a predefined upper limit threshold), the optimal cooling load calculator 252 may control the set temperature of the second cooling device 340b to be lowered. Here, the upper limit threshold may be defined as an upper limit temperature value to which the temperature of the cooling device can be increased. If it is determined that the set temperature of the first cooling device 340a can be changed, the optimal cooling load calculator 252 may control the set temperature of the first cooling device 340a to be lowered.

If temperature information is collected at a preset threshold value or higher for a predefined period of time in the process of detecting whether overcooling or overheating of electronic devices occurs, the optimal cooling load calculator 252 may control the set temperature adjustment of cooling devices. The predefined period of time may be, for example, several minutes. In this process, the optimal cooling load calculator 252 may monitor temperature changes by repeatedly collecting temperature information a preset number of times for a predefined period of time. Through this control, the optimal cooling load calculator 252 may prevent temperature adjustment from occurring too frequently.

The air conditioner controller 253 may transmit the cooling system control information transmitted by the optimal cooling load calculator 252 to the cooling system 300 of the telecommunication building through the server communication circuit 210. In this regard, the air conditioner controller 253 may form a communication channel with the cooling system 300 and transmit the cooling system control information to the cooling system 300 through the communication channel. In addition, when the air conditioner controller 253 receives a control signal related to the cooling system 300 control of the administrator terminal 100 from the information provider 254, it may transmit the received control signal to the cooling system 300.

The information provider 254 may generate information related to the operation of the cooling system 300 and provide the generated cooling system operation information to the administrator terminal 100. In this process, the information provider 254 may create a screen corresponding to the cooling system operation information and provide the screen to the administrator terminal 100. Additionally, when the information provider 254 may receive a control signal related to the cooling system 300 control from the administrator terminal 100, and transmit it to the air conditioner controller 253.

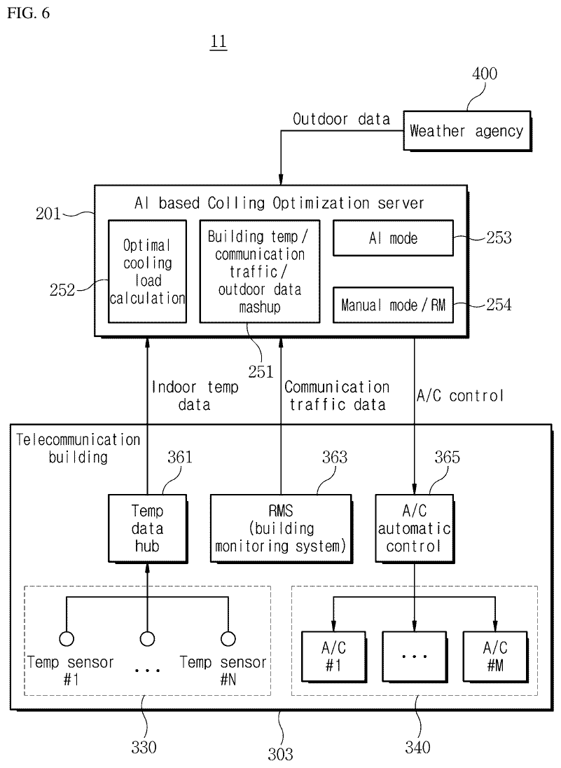

FIG. 6 is a diagram illustrating another example of a cooling system operating environment according to an embodiment of the present disclosure.

Referring to FIG. 6, the cooling system operating environment 11 according to an embodiment may include a cloud server 201 and a third type telecommunication building 303. In addition, the cooling system operating environment 11 may further include a weather agency server 400.

The third type telecommunication building 303 may include a plurality of temperature sensors 330, a plurality of cooling devices 340, a temperature data hub 361, a monitoring system 363, and an air conditioner automatic control system 365. Here, the cooling system of the third type telecommunication building 303 may include, for example, at least some of the plurality of temperature sensors 330, the plurality of cooling devices 340, the monitoring system 363, the temperature data hub 361, and the air conditioner automatic control system 365.

The plurality of temperature sensors 330 may be respectively disposed at designated locations of the third type telecommunication building 303. In an example, the plurality of temperature sensors 330 may be disposed so as to collect temperature information of various locations of electronic devices arranged in the first type telecommunication building 301. Or, the plurality of temperature sensors 330 may be disposed at least one by one in each control area of the plurality of cooling devices 340 arranged so as to reduce heat generation of the electronic devices. The plurality of temperature sensors 330 may collect temperature information at designated cycles or in real time, and transmit the collected temperature information to the temperature data hub 361.

The plurality of cooling devices 340 may be disposed at various locations of the third type telecommunication building 303. Or, the plurality of cooling devices 340 may be arranged to be spaced apart at a predefined regular interval and to discharge cooling air based on control areas where the electronic devices are placed in the third type telecommunication building 303. In an example, as described above, the plurality of cooling devices 340 may be arranged so as to discharge cooling air from the edge of the isolation facility toward the center.

The temperature data hub 361 may collect temperature information of the plurality of temperature sensors 330 and transmit it to the cloud server 201. The temperature data hub 361 may be, for example, at least a part of the data processing unit 350 described in FIG. 2.

The monitoring system 363 may detect the volume of communication traffic transmitted and received through the third type telecommunication building 303 and transmit the detected communication traffic volume to the cloud server 201. In an example, if the communication traffic volume of electronic devices of the third type telecommunication building 303 exceeds a predefined value and continues for a specified period of time, the monitoring system 363 may transmit information on the detected communication traffic volume to the cloud server 201.

The air conditioner automatic control system 365 may receive cooling system control information (or air conditioner control information) from the cloud server 201 and provide at least a part of the received cooling system control information to the plurality of cooling devices 340. In this process, the air conditioner automatic control system 365 may check the cooling system control information to identify a cooling device requiring temperature adjustment, and transmit a control signal to at least one cooling device. In an example, the air conditioner automatic control system 365 may generate and transmit a control signal for controlling one or more cooling devices in order to adjust a heating state or an overcooling state of an electronic device placed in a specific area. The air conditioner automatic control system 365 may be configured to include, for example, at least one of the remote controller and the individual controller or the data collector and the communication circuit described above.

The cloud server 201 may operate as an AI-based cooling optimization server. The cloud server 201 may include, for example, an optimal cooling load calculator 252, a data collector 251 (collecting building temperature/communication traffic/outdoor air data), an air conditioner controller 253 (or AI mode), and an information provider 254 (or manual mode/RM). The cloud server 201 may collect outdoor air data from the weather agency server 400 and generate cooling system control information for controlling the cooling system 300 based on the collected outdoor air data and the predicted communication traffic volume received from the third type telecommunication building 303. The cloud server 201 may perform operations corresponding to those of the server processor 250 of the cloud server 200 described above in FIG. 5.

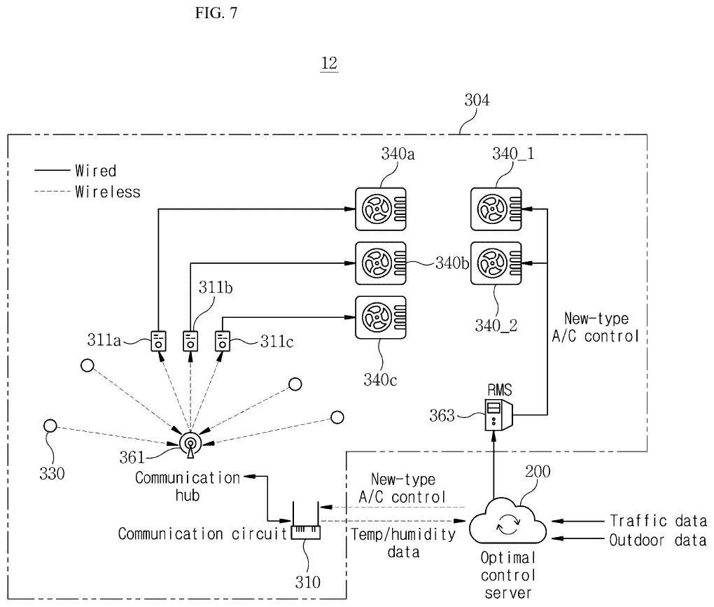

FIG. 7 is a diagram illustrating yet another example of a cooling system operating environment according to an embodiment of the present disclosure.

Referring to FIG. 7, the cooling system operating environment 12 according to an embodiment may include a cloud server 200 (or an optimal control server) and a fourth type telecommunication building 304.

The cloud server 200 may have the same or similar configuration as the cloud server described in FIG. 5 or FIG. 6 above. For example, the cloud server 200 may collect outdoor air data from the weather agency server and collect traffic data from the fourth type telecommunication building 304. The cloud server 200 may calculate a predicted outdoor temperature and a predicted communication traffic volume through learning based on the collected outdoor air data and traffic data, and, in response to the calculated predicted outdoor air temperature and the predicted communication traffic volume, may calculate a heat generation temperature to be generated in an electronic device, an expected temperature of the fourth type telecommunication building 304 according to the heat generation temperature, and a set temperature of at least one cooling device accordingly. The cloud server 200 may transmit cooling system control information including the calculated set temperature value to the cooling system of the fourth type telecommunication building 304.

The fourth type telecommunication building 304 may include, for example, first to third old-type cooling devices 340a, 340b, and 340c, a fourth new-type cooling device 340_1, and a fifth new-type cooling device 340_2. In addition, the fourth type telecommunication building 304 may include first to third individual controllers 311a, 311b, and 311c wiredly connected to the first to third old-type cooling devices 340a, 340b, and 340c, a remote monitoring system (RMS) 363 for controlling the fourth and fifth new-type cooling devices 340_1 and 340_2, a communication hub 361 for transmitting a control signal to the first to third individual controllers 311a, 311b, and 311c, and a communication circuit 310 connected to the communication hub 361. The communication hub 361 may be wirelessly connected to the first to third individual controllers 311a, 311b, and 311c. The communication hub 361 may be connected to a plurality of temperature sensors 330. The plurality of temperature sensors 330 may be wirelessly connected to the communication hub 361. The communication hub 361 may have, for example, a configuration identical or similar to the temperature data hub 361 described above in FIG. 6. The communication hub 361 may be wiredly connected to the communication circuit 310 in an RS232 manner. Alternatively, the communication hub 361 may be wirelessly connected to the communication circuit 310. The fourth and fifth new-type cooling devices 340_1 and 340_2 may be wiredly connected to the RMS 363.

The cloud server 200 may receive temperature and humidity data including temperature information (additionally humidity information) collected by the temperature sensors 330 through the communication circuit 310, and receive information on the communication traffic volume of the fourth type telecommunication building 304 through the RMS. In addition, the cloud server 200 may collect outdoor air data corresponding to the location of the fourth type telecommunication building 304, and generate first control information for controlling the old-type cooling device and second control information for controlling the new-type cooling device. The cloud server 200 may transmit the first control information to the first to third individual controllers 311a, 311b, and 311c through the communication circuit 310 and the communication hub 361. The cloud server 200 may transmit the second control information to the fourth and fifth new-type cooling devices 340_1 and 340_2 through the RMS 363.

As described above, the fourth type telecommunication building 304 according to an embodiment of the present disclosure can not only operate separate individual controllers to control the old-type cooling devices, but also utilize the RMS 363 to control the new-type cooling devices. Here, if the old-type cooling devices are fixed-speed on/off cooling devices, and the new-type cooling devices are cooling devices capable of varying the cooling degree, it is possible to support efficient temperature adjustment of the telecommunication building by operating the old-type cooling devices and the new-type cooling devices alternately or in combination. For example, the cloud server 200 may independently or intermittently operate the fourth new-type cooling device 340_1 and the fifth new-type cooling device 340_2 while basically operating the first to third old-type cooling devices 340a, 340b, and 340c. For example, the cloud server 200 may operate only the first to third old-type cooling devices 340a, 340b, and 340c until the communication traffic volume increases beyond a specified volume, and may selectively operate at least one of the fourth and fifth new-type cooling devices 340_1 and 340_2 when the communication traffic volume increases beyond the specified volume. Or, the cloud server 200 may divide the fourth type telecommunication building 304 into three control areas, place the old-type cooling devices 340a, 340b, and 340c in the control areas, respectively, place the new-type cooling devices 340_1 and 340_2 between the three control areas, and then selectively operate at least one of the new-type cooling devices 340_1 and 340_2 based on the predicted heat generation amount of the control area (or the control area with an electronic device entering an overheated state due to an increase in communication traffic).

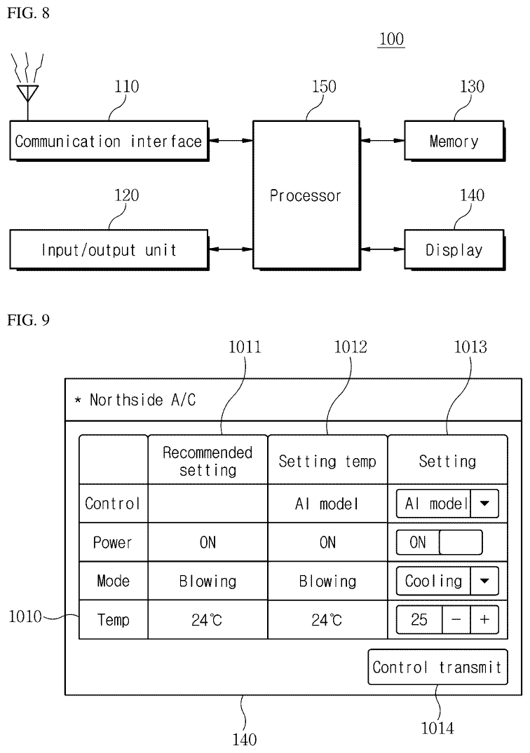

FIG. 8 is a diagram illustrating an example of a configuration of an administrator terminal according to an embodiment of the present disclosure.

Referring to FIG. 8, the administrator terminal 100 may include a communication interface 110, an input/output unit 120, a memory 130, a display 140, and a processor 150.

The communication interface 110 (or a communication circuit) may support forming a communication channel of the administrator terminal 100. In this regard, the communication interface 110 may include a communication circuit or a communication chip corresponding to at least one communication generation. For example, the communication interface 110 may include at least one communication circuit among a 3G communication circuit, a 4G communication circuit, and a 5G communication circuit. The communication interface 110 may receive information related to the operation of the cooling system 300 from the cloud server 200. For example, the communication interface may receive cooling system operation information related to temperature adjustment of at least one cooling device disposed in a control area to control cooling according to the predicted communication traffic volume. The communication interface 110 may transmit an air conditioner control signal (e.g., a control signal for temperature adjustment of at least one cooling device included in the cooling system 300) inputted through the input/output unit 120 (or the display 140) to the cloud server 200 through the network 51.

The input/output unit 120 may include at least one input tool for supporting the input function of the administrator terminal 100 and at least one output tool for supporting the information output function of the administrator terminal 100. For example, the input tool of the input/output unit 120 may include a touch key, a touch pad, a physical button, a mouse, etc. In addition, the input/output unit 120 may include a microphone related to supporting a voice input function. Meanwhile, when the display 140 is configured as a touch screen, the display 140 may be a component of the input/output unit 120. The output tool of the input/output unit 120 may include, for example, an audio device capable of outputting an audio signal, a vibration module capable of outputting a signal of a specified vibration pattern, an LED or lamp capable of outputting light of a certain color, etc. The input/output unit 120 may receive an administrator's input for manually controlling the set temperature of at least one cooling device among a plurality of cooling devices included in the cooling system 300 deployed in the telecommunication building, and then transmit the received administrator's input to the processor 150.

The memory 130 may store at least one program related to the operation of the administrator terminal 100 and data necessary for the operation of the program. For example, the memory 130 may store an operating system necessary for the operation of the administrator terminal 100, operation information of the cooling system 300, and an application that supports at least one of air conditioner controls of the cooling system 300.

The display 140 may support the display function of the administrator terminal 100. The display 140 may output various screens necessary for the operation of the administrator terminal 100. For example, the display 140 may output at least one screen among a home screen, a screen for access to the cloud server 200, and a screen related to the operation of the cooling system 300. In relation to the operation of the cooling system 300, the display 140 may output at least one of a cooling system setting information screen and a cooling system operation status screen. The display 140 may be provided in the form of a touch screen, and in this case, the display 140 may operate as an input tool of the input/output unit 120.

The processor 150 may control the processing and transmission of signals required for the operation of the administrator terminal 100, the storage of various kinds of information, etc. The processor 150 of the present disclosure may control forming a communication channel with the cloud server 200 through the network 51 in response to a user's manipulation, and receive a screen related to the operation of the cooling system 300 supported by the cloud server 200 and output it to the display 140. For example, the processor 150 can receive cooling system setting information among the operation information of the cooling system 300 from the cloud server 200 and output it to the display 140. The processor 150 may receive an administrator's input for temperature adjustment of at least one cooling device of the cooling system 300 through the cooling system setting information, and then transmit a corresponding control signal to the cloud server 200. In addition, the processor 150 may request the operating status of the cooling system 300 from the cloud server 200 in response to an administrator's input, and upon receiving information on the operating status of the cooling system from the cloud server 200, control outputting it to the display 140.

In another example, the processor 150 may collect the outdoor temperature value (or outdoor temperature) of the area where the telecommunication building is located, from the weather agency server that provides weather information, and learn the past monthly/weekly/daily traffic usage using electronic devices deployed in the telecommunication building. The processor 150 may collect information on the control areas governed by the plurality of cooling devices included in the cooling system 300, and manage the temperatures of the electronic devices for each control area. That is, when the administrator terminal 100 is configured to replace the function of the cloud server 200, the cloud server 200 is excluded from the structure described above in FIG. 1, and the administrator terminal 100 may receive cooling-related information of the telecommunication building, predict the volume of communication traffic, predict the outdoor temperature, and control the temperature of at least some of the cooling devices accordingly.

FIG. 9 is a diagram illustrating an example of a screen interface provided in a cooling system operating environment according to an embodiment of the present disclosure.

Referring to FIG. 9, a screen interface provided in an operating environment of a cooling system according to an embodiment of the present disclosure may be generated in the cloud server 200 and provided to the administrator terminal 100. The administrator terminal 100 may receive the screen interface from the cloud server 200 and output it to the display 140.

The display 140 may output, for example, cooling system setting information 1010. The cooling system setting information 1010 may include, for example, a recommended setting field 1011, a set temperature field 1012, and a setting field 1013. The recommended setting field 1011 may be a field that outputs a value calculated to optimally operate the cooling system 300 based on the predicted outdoor temperature and the predicted communication traffic volume collected by the cloud server 200.

The set temperature field 1012 may be a field indicating the current set temperature status of a specific cooling device related to the cooling system setting information 1010 among a plurality of cooling devices.

The setting field 1013 may be a field where an administrator can input temperature adjustment of a specific cooling device related to the cooling system setting information 1010. The administrator can manually adjust the temperature of a specific cooling device by touching the setting field 1013.

A control transmission button 1014 may be a software button (or a virtual object outputted on the display 140) for transmitting a control signal for temperature adjustment of a cooling device inputted through the setting field 1013 to the cloud server 200 (or the cooling system 300). When the control transmission button 1014 is touched, the administrator terminal 100 may transmit the information inputted in the setting field 1013 to the cloud server 200.

Meanwhile, although the screen interface is described as being provided by the cloud server 200, the present disclosure is not limited thereto. For example, the screen interface may be generated and outputted by an application installed on the administrator terminal 100 itself based on cooling-related information provided by the telecommunication building.

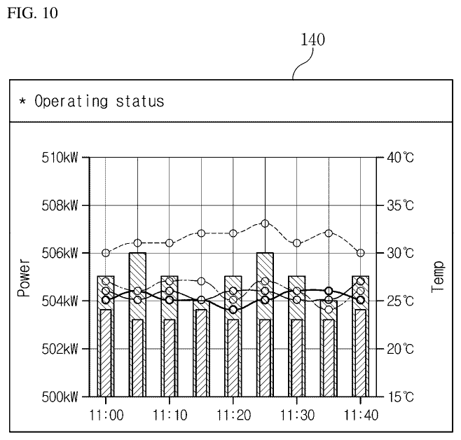

FIG. 10 is a diagram illustrating another example of a screen interface provided in a cooling system operating environment according to an embodiment of the present disclosure.

Referring to FIG. 10, a screen interface provided in an operating environment of a cooling system according to an embodiment of the present disclosure may be generated in the cloud server 200 and provided to the administrator terminal 100. The administrator terminal 100 may receive the screen interface from the cloud server 200 and output it to the display 140.

The display 140 may output, for example, information on the operating status of the cooling system from the cloud server 200. In this regard, the administrator terminal 100 may receive only numerical values related to the operating status of the cooling system, generate a graph as shown based on the received numerical values, and output it to the display 140. Alternatively, the administrator terminal 100 may receive graph information from the cloud server 200 and output the received graph information as it is to the display 140. Meanwhile, if a temperature higher than a predefined value is detected when outputting the operating status, the administrator terminal 100 may highlight and output the relevant part so that the administrator can easily recognize it.

The operating status graph outputted by the display 140 may include, for example, power amount and temperature values detected at a specified time cycle. Based on an administrator's input, the administrator terminal 100 may request operating status information of a different time zone from the cloud server 200 and update the screen of the display 140 to output the operating status information of a different time zone.

In another example, the administrator terminal 100 may collect only sections having a predefined power amount or more or sections having a predefined temperature value or more, and output the collected information to the display 140.

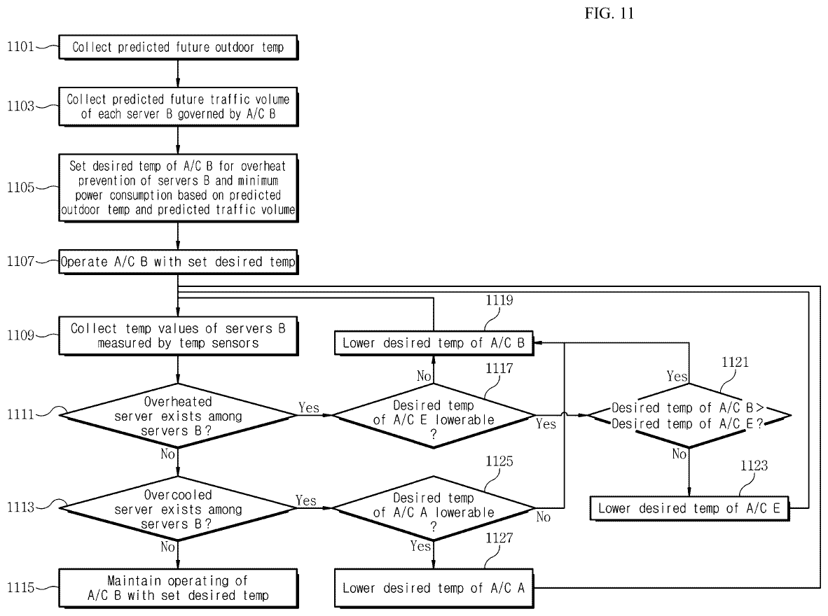

FIG. 11 is a diagram illustrating an example of a device operating method of a cloud server related to the operation of a cooling system according to an embodiment of the present disclosure.

Referring to FIG. 11, in relation to the device operation method of the cloud server according to an embodiment of the present disclosure, in step 1101, the server processor 250 of the cloud server 200 may collect a predicted outdoor temperature in the future. For example, the server processor 250 may access the weather agency server to collect the outdoor temperature at the location of the telecommunication building (e.g., 301, 302, 303) where the cooling system 300 is deployed, and calculate the predicted outdoor temperature based on the current time and season. Alternatively, the server processor 250 may derive temperature values in conditions where at least some of the location of the telecommunication building, the current time, the weather, and the season are the same or similar, from a table of accumulated outdoor temperatures pre-stored in the server memory 230 through comparative analysis, or collect the predicted outdoor temperature in the same or similar conditions from the weather agency server. Alternatively, the server processor 250 may calculate the outdoor temperature at a certain future point in time (e.g., several minutes or hours from now) based on previous temperature values collected by temperature sensors placed outside the telecommunications building and weather, time, and season information at the time the temperature values were stored.

In step 1103, the server processor 250 may calculate the predicted traffic volume of an electronic device (or communication traffic processing device, traffic processing server device) disposed in a specific control area. In this regard, the server processor 250 may store and manage accumulated information on the communication traffic volumes of electronic devices disposed in the telecommunication building, and based on this, calculate the predicted traffic volume under the same or similar conditions. For example, the server processor 250 may calculate the predicted communication traffic volume after a certain time (e.g., several minutes or hours later) from the present by referring to previous history of communication traffic volume at the same or similar time, day of the week, and season, or in the event of a specific issue occurrence.

In step 1105, the server processor 250 may set the temperature of a first cooling device of the control area based on the predicted outdoor temperature and the predicted traffic volume. Here, the set temperature of the cooling device determined by the server processor 250 may be calculated in consideration of overheating prevention and minimum power of the electronic device. For example, the set temperature may be a certain temperature value between overheating and overcooling, a temperature value set so that the electronic device can achieve optimal efficiency, or a temperature value (or a midpoint between minimum and maximum values of a certain temperature range) at which the electronic device can achieve optimal efficiency as defined in the specifications of the electronic device.

In step 1107, the server processor 250 may transmit the determined set temperature to a first cooling device in the control space. Here, the first cooling device may be a device disposed to mainly discharge cooling air to the control space. The control space setting for each cooling device may be performed by the administrator at the time when the cooling devices are arranged.

In step 1109, the server processor 250 may collect temperature information of the control area. In this regard, the telecommunication building operates temperature sensors disposed at multiple locations, and the server processor 250 may collect temperature information from a temperature sensor placed in the control area among the multiple temperature sensors. Here, each of the temperature sensors has identification information, and the server processor 250 may distinguish the temperature information provided by the temperature sensor placed in the control area of the first cooling device, based on the identification information of the temperature sensors matched in advance for each control space.

In step 1111, the server processor 250 may check whether there is an electronic device entering an overheated state among the electronic devices in the control area. For example, if the collected temperature information of the control area indicates a temperature value higher than a specified temperature value, the server processor 250 may determine that the electronic device in the control area enters an overheated state.

If the temperature information is different from the overheated state entry situation of the electronic device, the server processor 250 may check in step 1113 whether there is an electronic device entering an overcooled state among the electronic devices in the control area. In this regard, the temperature information indicating an overcooled or overheated state may be predefined.

If the temperature information of the control area is a temperature value that does not indicate an overcooled state, in step 1115, the server processor 250 may control the first cooling device of the control area to maintain the operation at the previously determined set temperature.

On the other hand, if there is an overheated electronic device in step 1111, the server processor 250 may check in step 1117 whether the set temperature of another second cooling device that affects the cooling of the control area is adjustable. For example, if the temperature information is a temperature value that indicates an overheated state of the electronic device, the server processor 250 may check whether the set temperature of the second cooling device is adjustable.

If the set temperature of the second cooling device is not adjustable, the server processor 250 may further adjust the set temperature of the first cooling device in step 1119. For example, if the current set temperature of the second cooling device is a predefined minimum temperature, the server processor 250 may determine that set temperature adjustment of the second cooling device is impossible.

If the set temperature adjustment of the second cooling device is possible, the server processor 250 may check in step 1121 whether the set temperature of the first cooling device is higher than the set temperature of the second cooling device. If the set temperature of the first cooling device is higher than the set temperature of the second cooling device, the server processor 250 may further adjust the set temperature of the first cooling device in step 1119. For example, the server processor 250 may control the set temperature of the first cooling device to be further lowered by a preset temperature.

If the set temperature of the first cooling device is lower than or equal to the set temperature of the second cooling device, the server processor 250 may adjust the set temperature of the second cooling device in step 1123. For example, the server processor 250 may control the set temperature of the second cooling device to be further lowered.

On the other hand, if there is an overcooled electronic device in step 1113, the server processor 250 may check in step 1125 whether the set temperature of another third cooling device affecting the cooling of the control area is adjustable. If the set temperature adjustment of the third cooling device is impossible, the server processor 250 may adjust the set temperature of the first cooling device in step 1119. For example, if the set temperature of the third cooling device has reached a predefined upper threshold value, the server processor 250 may determine that the temperature adjustment of the third cooling device is impossible.

If the set temperature adjustment of the third cooling device is possible in step 1125, the server processor 250 may adjust the set temperature of the third cooling device in step 1127. For example, the server processor 250 may control the set temperature of the third cooling device to increase by a specified temperature. In another example, the server processor 250 may compare the set temperatures of the first and third cooling devices that affect the cooling of the control area, and control the set temperature of the cooling device that is set relatively low to be increased.

As described above, the cooling function control method for the telecommunication building according to an embodiment of the present disclosure sets the operating temperature of the cooling device to consume minimal power while preventing overheating of heat-generating electronic devices (or servers), based on the predicted outdoor temperature and the predicted traffic volume at the time of control. The higher the predicted outdoor temperature and the greater the predicted traffic volume, the lower the set temperature can be set.

The present disclosure described above is for preventing overheating and overcooling of multiple air conditioners, and can collect the predicted outdoor temperature and the predicted traffic volume of electronic devices (or server devices that process communication traffic) controlled by a specific cooling device. In this process, the present disclosure can derive the predicted traffic volume through learning based on the past traffic volume.

The steps described above in FIG. 11 can be performed for all multiple air conditioners so that all multiple air conditioners can be operated at appropriate set temperatures, thereby preventing the occurrence of overheating and overcooling servers (or electronic devices) and reducing unnecessary energy usage due to the operation of the multiple air conditioners.

While the description contains many specific implementation details, these should not be construed as limitations on the scope of the present disclosure or of what may be claimed, but rather as descriptions of features that may be specific to particular embodiments of particular disclosure.

Also, although the description describes that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

The description shows the best mode of the present disclosure and provides examples to illustrate the present disclosure and to enable a person skilled in the art to make and use the present disclosure. The present disclosure is not limited by the specific terms used herein. Based on the above-described embodiments, one of ordinary skill in the art can modify, alter, or change the embodiments without departing from the scope of the present disclosure.

Accordingly, the scope of the present disclosure should not be limited by the described embodiments and should be defined by the appended claims.

1. A cooling function control method for a telecommunication building, the method comprising:
by a server device, calculating a predicted communication traffic volume processed through the telecommunication building;
by the server device, detecting a control area in which an electronic device expected to overheat is disposed, from the telecommunication building divided into a plurality of control areas, based on the predicted communication traffic volume;
by the server device, generating first cooling system control information for adjusting a set temperature of a first cooling device to be lowered by a predefined value, the first cooling device being disposed for temperature adjustment of the detected control area from among a plurality of cooling devices arranged in the telecommunication building; and
by the server device, transmitting the first cooling system control information to the first cooling device.

2. The method of claim 1, further comprising:
collecting temperature information from a temperature sensor disposed in the detected control area;
maintaining temperature setting of the first cooling device when the temperature information is below a predefined value.

3. The method of claim 1, further comprising:
collecting temperature information from a temperature sensor disposed in the detected control area;
generating second cooling system control information for adjusting the set temperature of the first cooling device to be further lowered by a predefined value when the temperature information is greater than or equal to a predefined value, and transmitting the second cooling system control information to the first cooling device.

4. The method of claim 1, further comprising:
collecting temperature information from a temperature sensor disposed in the detected control area;
checking whether the set temperature of the first cooling device is a predefined lower threshold value when the temperature information is greater than or equal to a predefined value;
generating third cooling system control information for adjusting a set temperature of a second cooling device which affects cooling of the detected control area to be lowered when the set temperature of the first cooling device is the predefined lower threshold value, and transmitting the third cooling system control information to the second cooling device.

5. The method of claim 1, further comprising:
collecting temperature information from a temperature sensor disposed in the detected control area;
comparing a set temperature of a second cooling device which affects cooling of the detected control area with the set temperature of the first cooling device when the temperature information is higher than or equal to a predefined value;
generating fourth cooling system control information for adjusting a set temperature of a cooling device having a relatively higher set temperature as a result of the comparison to be lowered, and transmitting the generated fourth cooling system control information to the corresponding cooling device.

6. The method of claim 1, further comprising:
transmitting information related to cooling control of the telecommunication building to an administrator terminal;
receiving a control signal related to the cooling control from the administrator terminal;
transmitting the control signal to at least one cooling device of the telecommunication building.

7. The method of claim 1, further comprising:
collecting temperature information from a temperature sensor disposed in the detected control area;
when the temperature information is below a predefined overcooling temperature value, checking whether set temperature adjustment of another third cooling device affecting cooling of the control area is possible;
adjusting the set temperature of the first cooling device when the set temperature adjustment of the third cooling device is impossible, and adjusting the set temperature of the third cooling device when the set temperature adjustment of the third cooling device is possible.

8. A server device controlling a cooling function for a telecommunication building, the server device comprising:
a server memory storing at least one threshold value related to an operation of a cooling system;
a server communication circuit forming a communication channel with at least some components of the cooling system; and
a server processor functionally connected to the server memory and the server communication circuit,
wherein the server processor is configured to:
calculate a predicted communication traffic volume processed through the telecommunication building in which the cooling system is disposed,
detect a control area in which an electronic device expected to overheat is disposed, from the telecommunication building divided into a plurality of control areas, based on the predicted communication traffic volume,
generate first cooling system control information for adjusting a set temperature of a first cooling device to be lowered by a predefined value, the first cooling device being disposed for temperature adjustment of the detected control area from among a plurality of cooling devices arranged in the telecommunication building, and
transmit the first cooling system control information to the first cooling device.

9. The server device of claim 8, wherein the server processor is configured to:
collect temperature information from a temperature sensor disposed in the detected control area,
maintain temperature setting of the first cooling device when the temperature information is below a predefined value,
generate second cooling system control information for adjusting the set temperature of the first cooling device to be further lowered by a predefined value when the temperature information is greater than or equal to a predefined value, and transmit the second cooling system control information to the first cooling device, or
check whether the set temperature of the first cooling device is a predefined lower threshold value when the temperature information is greater than or equal to a predefined value, generate third cooling system control information for adjusting a set temperature of a second cooling device which affects cooling of the detected control area to be lowered when the set temperature of the first cooling device is the predefined lower threshold value, and transmit the third cooling system control information to the second cooling device.

10. The server device of claim 8, wherein the server processor is configured to:
collect temperature information from a temperature sensor disposed in the detected control area,
compare a set temperature of a second cooling device which affects cooling of the detected control area with the set temperature of the first cooling device when the temperature information is higher than or equal to a predefined value,
generate fourth cooling system control information for adjusting a set temperature of a cooling device having a relatively higher set temperature as a result of the comparison to be lowered, and transmit the generated fourth cooling system control information to the corresponding cooling device.

11. The server device of claim 8, wherein the server processor is configured to:
transmit information related to cooling control of the telecommunication building to an administrator terminal, and
upon receiving a control signal related to the cooling control from the administrator terminal, transmit the control signal to at least one cooling device of the telecommunication building.

12. The server device of claim 8, wherein the server processor is configured to:
collect temperature information from a temperature sensor disposed in the detected control area,
when the temperature information is below a predefined overcooling temperature value, check whether set temperature adjustment of another third cooling device affecting cooling of the control area is possible,
then adjust the set temperature of the first cooling device when the set temperature adjustment of the third cooling device is impossible, and adjust the set temperature of the third cooling device when the set temperature adjustment of the third cooling device is possible.
